(19) United States
(12) Patent Application Publication
(10) Pub. No.: US 2007/0034614 A1
(43) Pub. Date: Feb. 15, 2007

(54) Method of forming grooves in chemical mechanical polishing pad utilizing laser ablation

(76) Inventors: Harry George McClain, Middletown, DE (US); Alan H. Saikin, Landenberg, PA (US); Jeffrey R. Stack, Clayton, DE (US); Weitung Wang, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/492,241

(22) Filed: Jul. 25, 2006

Related U.S. Application Data
(60) Provisional application No. 60/706,921, filed on Aug. 10, 2005.

(51) Int. Cl. B23K 26/38; B23K 26/067

(52) U.S. Cl. 219/121.69; 219/121.76

(57) ABSTRACT

The present invention provides a method of forming a polishing pad for chemical mechanical planarization utilizing laser ablation. In particular, the method includes providing a laser to cut a groove into the polishing pad and providing a beam splitter to split a laser beam from the laser. Further, the method provides splitting the beam from the laser to provide multiple laser beams onto the polishing pad and wherein the multiple laser beams have effective cutting areas that at least overlap each other.

### CROSS REFERENCE TO RELATED APPLICATION

This application claims the benefit of U.S. Provisional Application Ser. No. 60/706,921 filed Aug. 10, 2005.

### FIELD OF THE INVENTION

The present invention relates to polishing pads used for chemical-mechanical planarization (CMP), and in particular relates to such pads that have grooves formed therein utilizing laser ablation.

### BACKGROUND OF THE INVENTION

In the fabrication of integrated circuits and other electronic devices, multiple layers of conducting, semiconducting, and dielectric materials are deposited on or removed from a surface of a semiconductor wafer. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electrochemical plating (ECP).

As layers of materials are sequentially deposited and removed, the uppermost surface of the substrate may become non-planar across its surface and require planarization. Planarizing a surface, or “polishing” a surface, is a process where material is removed from the surface of the wafer to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical mechanical planarization, or chemical mechanical polishing (CMP), is a common technique used to planarize substrates such as semiconductor wafers. In conventional CMP, a wafer carrier or polishing head is mounted on a carrier assembly and positioned in contact with a polishing pad in a CMP apparatus. The carrier assembly provides a controllable pressure to the substrate urging the wafer against the polishing pad. The pad is moved (e.g., rotated) relative to the substrate by an external driving force. Simultaneously therewith, a chemical composition (“slurry”) or other fluid medium is flowed onto the substrate and between the wafer and the polishing pad. The wafer surface is thus polished by the chemical and mechanical action of the pad surface and slurry in a manner that selectively removes material from the substrate surface.

Typically, grooves are machined or molded into the polishing pad. Unfortunately, these processes for forming grooves are limited in their ability to adapt to various shapes and patterns of the desired grooves. Accordingly, methods for forming grooves utilizing lasers have been investigated (e.g., U.S. Pat. No. 6,794,605). Unfortunately, as shown in FIGS. 1-2, a single beam 3 from a laser 5 that is irradiated onto polishing pad 1, forms a groove 9 that is sub-optimal for modern-day polishing performance requirements. For example, a bottom portion 7 of the groove 9 has very little to no texture, diminishing the groove's ability to transport slurry, and negatively impacting CMP. Furthermore, due to the Gaussian distribution of the laser beam (i.e., the center portion is greater in intensity than the outer portions), a “V” shaped (cross-sectional profile) groove is created, diminishing the surface area of the groove to transport slurry and negatively impacting CMP. In other words, the polishing pad 1 has a tapered width 15 that is greatly diminished relative to the width of the groove opening at the polishing surface of the polishing pad 2. Thus, the total surface area of the “V” shaped groove, when compared to that of a typical, square or rectangular shaped groove, is diminished.

Accordingly, what is needed is a method of forming a polishing pad for chemical-mechanical planarization utilizing a laser with an improved groove having increased texture and greater surface area for transporting slurry and improving polishing performances.

### SUMMARY OF THE INVENTION

In one aspect of the invention, there is provided a method of forming a polishing pad for chemical mechanical planarization utilizing laser ablation, comprising: providing a laser to cut a groove into the polishing pad; providing a beam splitter to split a laser beam from the laser; splitting the beam from the laser to provide multiple laser beams onto the polishing pad; and wherein the multiple laser beams have effective cutting areas that at least overlap each other.

In another aspect of the invention, there is provided a method of forming a polishing pad having grooves formed therein for chemical mechanical planarization, the grooves being formed by: cutting the pad to form the groove with a first laser beam and at least a second laser beam, wherein a first section cut by the first laser beam overlaps with a second section cut by the second laser beam.

In another aspect of the invention, there is provided a method of forming a polishing pad for chemical mechanical planarization, comprising: providing a first laser with a first laser beam; providing at least a second laser with another laser beam; radiating the first and another laser beams onto the polishing pad; and wherein the beams at least partially overlap each other to cut grooves into the polishing pad.

### BRIEF DESCRIPTION OF THE DRAWINGS

FIGS. 1-2 illustrate a cross-sectional view of a conventional polishing pad with a groove formed by a conventional single beam laser; and

FIGS. 3-4 illustrate a cross-sectional view of the polishing pad formed by utilizing the method of the present invention.

### DETAILED DESCRIPTION OF THE INVENTION

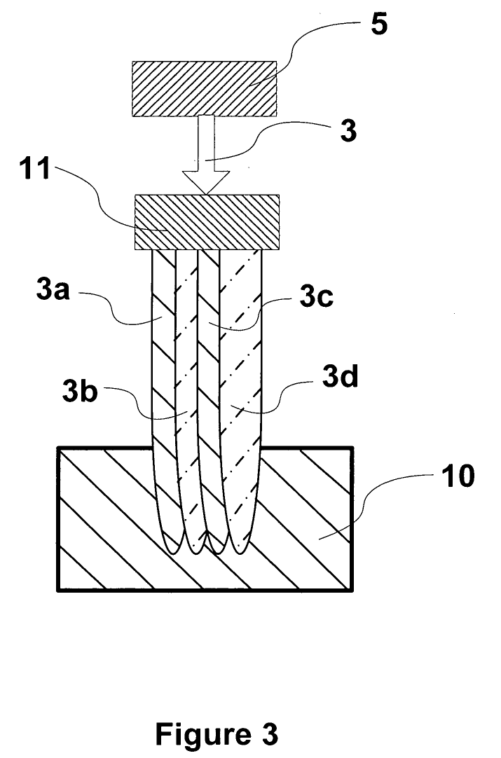

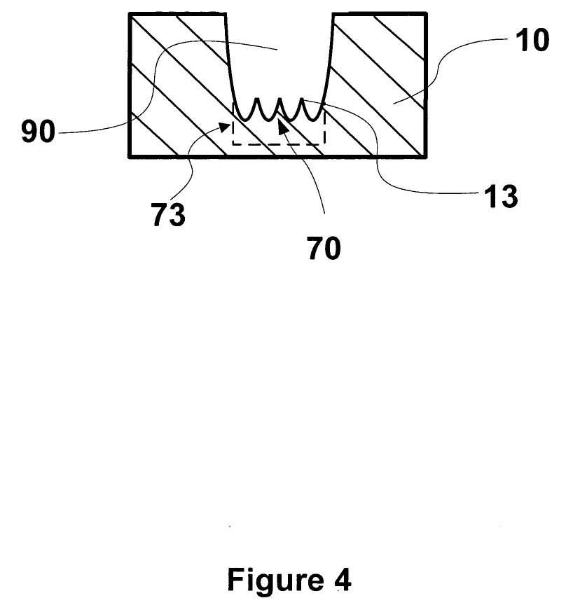

Referring to the drawings, FIGS. 3-4 illustrate a close-up cross-sectional view of a polishing pad 10. Polishing pad 10 may be any of the known polishing pads, such as urethane-impregnated felts, microporous urethane pads of the type sold under the tradename POLITEX by Rohm and Haas Electronic Materials CMP Inc. (“RHEM”), of Newark, Del., or filled and/or blown composite urethanes such as the IC-Series and MH-series pads, also manufactured by RHEM.

In the present invention, a laser beam 3 from a laser 5 is split by a beam splitter 11 to create multiple beams 3a, 3b, 3c and 3d. Alternatively, multiple lasers 5 may be utilized to create any number of multiple beams without a beam splitter 11, as desired. Note, any number of beams, 2 or more, may be utilized to practice the instant invention. Also, any commercially available beam splitter may be utilized, including lightweight mirrors, cylindrical mirrors, shutter mirrors, cassegrain mirrors, knife-edge mirrors and roof prisms. A roof prism is preferred as it is inexpensive, adjustable, polarization insensitive and will work with high powers. The multiple beams 3a-3d are irradiated onto the polishing pad 10 to form the novel grooves. Namely, as shown in FIG. 4, a groove 90 is formed in the polishing pad 10 having roughness 13 at the bottom portion 70. The roughness 13 provide improved texture to the groove 90, allowing improved ability to transport slurry during the polishing process.

Preferably, each of the beams 3a-3d overlap each other such that a net, non-Gaussian distribution of the energy from the beam is experienced by the polishing pad 10. In other words, by splitting the beam 3 to individual beams 3a-3d (with at least some overlap between the beams), the highest energy from the beam 3 is concentrated in each of the beams 3a-3d, such that the net, overall effect of the laser beam is broadly spread out throughout the beam 3 and not simply concentrated in the center as in prior art single beam methods. Thus, laser beams 3a-3d have effective cutting areas that at least overlap each other.

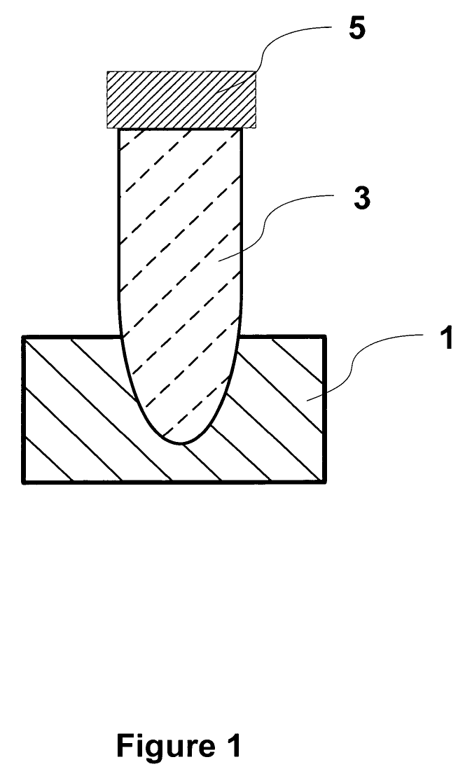

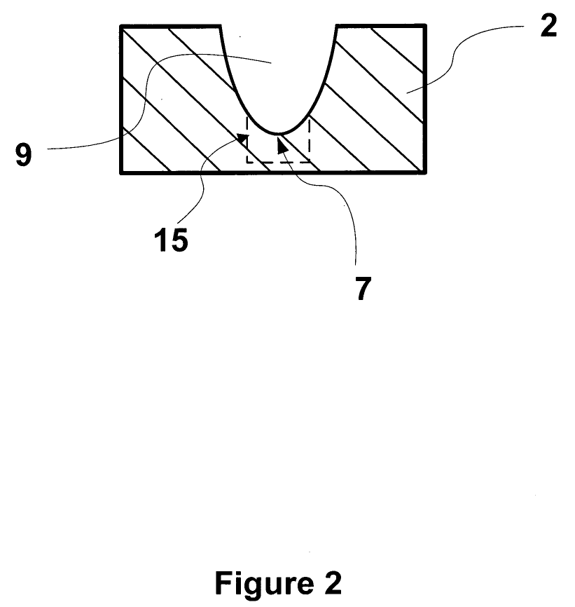

Furthermore, the surface area of the groove 90 is increased by providing a more, square or rectangular, cross-sectional profile as compared to a groove having a typical “V” shaped profile as illustrated in FIGS. 1-2. Preferably, the groove 90 of polishing pad 10 has a tapered width 73 that is at least greater than 90 percent of the width 75 of the groove opening at the polishing surface 17 of the polishing pad 10. In other words, in the polishing pad of the present invention, the difference between the tapered width 73 and the width 75 of the groove opening at the polishing surface 17 is not more than 10 percent. More preferably, the groove 90 of polishing pad 10 has a tapered width 73 that is at least greater than 93 percent of the width 75 of the groove opening at the polishing surface 17 of the polishing pad 10. Most preferably, the groove 90 of polishing pad 10 has a tapered width 73 that is at least greater than 95 percent of the width 75 of the groove opening at the polishing surface 17 of the polishing pad 10. In this way, the method of the present invention provides a groove having a cross-sectional profile that is more square or rectangular, allowing for increased surface area for improving, for example, slurry transport.

Note, laser 5 can be moved in any direction (i.e., x, y or z plane) to accommodate numerous designs or configurations as desired. In the present invention, any supporting member (not shown), for example, a table to support the polishing pad, need not be moved relative to the laser 5. Rather, laser 5 can be moved to achieve, for example, the desired groove 90 having roughness 13, independent of any movement of the supporting member. In addition, an inert gas may be provided from a nozzle (not shown) to reduce oxygen at the cutting surface, reducing burns or chars on the cutting surface edge. Also, the laser beam may be utilized in conjunction with a high pressure waterjet to reduce the heat that may be produced by conventional laser cutting processes.

In the present embodiment, the laser 5 used for micromachining may be pulsed excimer lasers that have a relatively low duty cycle. Optionally, laser 51 may be a continuous laser that is shuttered (i.e., the pulse width (time) is very short compared to the time between pulses). Even though excimer lasers have a low average power compared to other larger lasers, the peak power of the excimer lasers can be quite large. The peak intensity and fluence of the laser is given by:
Intensity (Watts/cm²)=peak power (W)/focal spot area (cm²)
Fluence (Joules/cm²)=laser pulse energy (J)/focal spot area (cm²)
   while the peak power is:
Peak power (W)=pulse energy (J)/pulse duration (sec)
Example lasers are STS™ Series lasers from PRC Laser Corporation. Thermal laser ablation is preferred.

During laser ablation, several key parameters should be considered. An important parameter is the selection of a wavelength with a minimum absorption depth. This should allow a high energy deposition in a small volume for rapid and complete ablation. Another parameter is short pulse duration to maximize peak power and to minimize thermal conduction to the surrounding work material. This combination will reduce the amplitude of the response. Another parameter is the pulse repetition rate. If the rate is too low, energy that was not used for ablation will leave the ablation zone allowing cooling. If the residual heat can be retained, thus limiting the time for conduction, by a rapid pulse repetition rate, the ablation will be more efficient. In addition, more of the incident energy will go toward ablation and less will be lost to the surrounding work material and the environment. Yet another important parameter is the beam quality. Beam quality is measured by the brightness (energy), the focusability, and the homogeneity. The beam energy is less useful if it can not be properly and efficiently delivered to the ablation region. Further, if the beam is not of a controlled size, the ablation region may be larger than desired with excessive slope in the sidewalls.

In addition, if the removal is by vaporization, special attention must be given to the plume. The plume will be a plasma-like substance consisting of molecular fragments, neutral particles, free electrons and ions, and chemical reaction products. The plume will be responsible for optical absorption and scattering of the incident beam and can condense on the surrounding work material and/or the beam delivery optics. Normally, the ablation site is cleared by a pressurized inert gas, such as nitrogen or argon.

Accordingly, the present invention provides a method of forming a polishing pad for chemical-mechanical planarization, utilizing a laser, with an improved groove having increased texture and greater surface area for transporting slurry and improving polishing performances. In particular, the method includes providing a laser to cut a groove into the polishing pad and providing a beam splitter to split a laser beam from the laser. Further, the method provides splitting the beam from the laser to irradiate multiple laser beams onto the polishing pad and wherein the multiple laser beams have effective cutting areas that at least overlap each other.

What is claimed is:

1. A method of forming a polishing pad for chemical mechanical planarization utilizing laser ablation, comprising:
providing a laser to cut a groove into the polishing pad;
providing a beam splitter to split a laser beam from the laser;
splitting the beam from the laser to provide multiple laser beams onto the polishing pad; and
wherein the multiple laser beams have effective cutting areas that at least overlap each other.

2. The method of claim 1, wherein the laser ablation is thermal laser ablation.

3. The method of claim 1, further comprising texturizing a bottom surface of the groove with the multiple laser beams.

4. The method of claim 1, wherein a tapered width of the groove is at least greater than 90 percent of a width of the groove opening at a polishing surface of the polishing pad.

5. A method of forming a polishing pad having grooves formed therein for chemical mechanical planarization, the grooves being formed by:
cutting the pad to form the groove with a first laser beam and at least a second laser beam, wherein a first section cut by the first laser beam overlaps with a second section cut by the second laser beam.

6. The method of claim 5, further comprising providing a beam splitter to form the first and the at least second laser beams.

7. The method of claim 5, further comprising texturizing a bottom surface of the groove with the multiple laser beams.

8. A method of forming a polishing pad for chemical mechanical planarization, comprising:
providing a first laser with a first laser beam;
providing at least a second laser with another laser beam;
radiating the first and another laser beams onto the polishing pad; and
wherein the beams at least partially overlap each other to cut grooves into the polishing pad.

9. The method of claim 8, wherein the laser beam is a thermal laser beam.

10. The method of claim 8, further comprising texturizing a bottom surface of the groove with the multiple laser beams.
